(19) United States
(12) Patent Application Publication
(10) Pub. No.: US 2017/0084972 A1
(43) Pub. Date: Mar. 23, 2017

(54) RF FILTER

(71) Applicant: TONGYU TECHNOLOGY OY, Espoo (FI)

(72) Inventor: Erkki Niiranen, Ii (FI)

(21) Appl. No.: 15/311,392

(22) PCT Filed: May 22, 2015
(86) PCT No.: PCT/FI2015/050356

§ 371 Date: Nov. 15, 2016

(30) Foreign Application Priority Data
May 23, 2014 (FI) 20145470

(51) Int. Cl. H01P 1/213; H01P 3/08

(52) U.S. Cl. CPC H01P 1/2135; H01P 3/08

(57) ABSTRACT

An RF filter, particularly a stripline type RF filter, includes a casing and two or more strip-conductor-type resonators in the casing. At a distance from the ends of the resonator, between the resonator sides, there are one or more coupling lines forming an integral piece with the resonators.

### CROSS-REFERENCE TO RELATED APPLICATIONS

This application is a National Stage application of International Application No. PCT/F12015/050356, filed May 22, 2015, which claims benefit to Finnish Application No. FI 20145470, filed May 23, 2014, which are incorporated by reference herein in their entirety.

### BACKGROUND

Field

The invention relates to an RF filter.

Description of the Related Art

RF filters, i.e. radio frequency filters, are used in connection with RF devices, such as transmitters, receivers or transceivers, used in base stations of mobile phone networks, for example.

Resonator type filters comprise a casing structure with one or more compartments whose shape is defined by the wall structure of the casing.

Typically, a compartment of the casing structure may contain an inner conductor, referred to as a resonator or a resonator pin, attached to the bottom of the compartment or cavity, a common structure being a coaxial resonator in which the inner conductor, or the resonator, shares a common axis, i.e. is coaxial, with the surrounding compartment or cavity. A compartment in a metal casing and a metal inner conductor together form a resonant circuit. In more complex high frequency filters in particular the casing structure consists of plural compartments, each compartment having a separate inner conductor, or resonator, whereby a plural number of resonant circuits is formed and, with a suitable intercoupling of these, desired frequency responses, i.e. stopbands and passbands, are obtained.

In a stripline type filter, the inner conductors, or resonators, are fairly thin parallel conductive strips, i.e. strip conductors, extending in parallel in a space between two ground plane walls (electric ground potential) of the casing, and the resonator ends are short-circuited to an end between the casing walls.

In prior art stripline filters the resonators are separate from one another. In other than stripline type filters, i.e. in coaxial resonator filters, it is known to use a structure according to publication U.S. Pat. No. 5,892,419, in which the resonator ends are short-circuited by a common base that forms a single piece with the resonators and may, at the same time, form part of the casing bottom. In coaxial resonator filters, the structures for setting or modifying operating settings, such as the frequency response, of the filters are separate parts added to the resonators as is known from publication U.S. Pat. No. 6,198,363, for example, which discloses a transverse plate provided with adjusting members and attached to the free end, also known as the capacitive end, of a coaxial resonator.

In prior art solutions the integral character of the construction has not been made advanced enough, and the parts modifying the frequency response of the filter are separate parts that must be attached to the resonator.

### SUMMARY

An object of the invention is thus to provide an RF filter so as to enable the aforementioned problems to be solved or alleviated.

The object of the invention is achieved by an RF filter which is characterized by what is disclosed in the independent claim. Preferred embodiments of the invention are disclosed in the dependent claims.

An advantage of the invention is that it provides a higher degree of integration of the construction and easier manufacturability as well as a more reliable connection between the resonator and additional structures associated with it. Moreover, it is easier to obtain a desired frequency response.

### BRIEF DESCRIPTION OF THE DRAWINGS

The invention will be described in greater detail in connection with some embodiments, with reference to the accompanying drawings, in which:

FIG. 1 illustrates an RF filter as seen from the direction of the cover of the casing;

FIG. 2 illustrates frequency adjustment members on the filter cover;

FIG. 3 illustrates adjustment members integrated with adjacent resonators for adjusting a capacitive coupling between the resonators;

FIG. 4 illustrates a frequency adjustment member integrated with a resonator.

### DETAILED DESCRIPTION

With reference to the figures, an RF filter F is disclosed, which filter F may be used in connection with or coupled to an RF device, such as a transmitter, a receiver, a transceiver or an amplifier. The RF device may be a radio unit in a cellular radio network or a module thereof, for example.

References 102 and 104 and 106 indicate transfer lines to which signal ports, such as coaxial connectors may be connected, the signal ports, in turn, may be connected to by means of cables that connect the filter F to an antenna and, for example, to a transceiver.

The filter F is a stripline type filter comprising strip-conductor-type resonators 110, 112, 114, 116 and strip-conductor-type resonators 140, 142, 144, 146, and a casing C with casing sides B, T and ends C1 to C4. A minimum of two resonators are provided. In the example of FIG. 1 the resonators are in two groups so that between the resonator groups 110, 112, 114, 116 and, on the other hand, 140, 142, 144, 146 there is a 2-branch phasing line 130, or a similar signal line, connecting the resonator groups to a common signal port over a transfer line 106. It may be seen that the transfer line 106 is the end part of the phasing line 130, i.e. the end on the signal port side of the phasing line. The resonators 110, 112, 114, 116 belong to a LOW-BAND type filter, i.e. to a lower frequency band filter having a frequency band of 696 to 795 MHz, for example. Correspondingly, the resonators 140, 142, 144, 146 belong to a HIGH-BAND type filter, i.e. to a higher frequency band filter having a frequency band of 822 to 898 MHz, for example. Both branches of the phasing line 130 have a length of a quarter wave, when examined at the average filter frequency.

Characteristically of a stripline type filter, the stripline type resonators 110, 112, 114, 116 and 140, 142, 144, 146 are inside the casing C, in an area between the sides B, T of the casing C that are grounded to a common ground. To make the structures inside the casing C visible, FIG. 1 only shows a small part of the side cover T.

The ends of the resonators 110, 112, 114, 116, i.e. the bottom parts of the resonators in FIG. 1, are short-circuited to an end C1 of the casing C, the end acting at the same time as a common ground 132 for the resonators 110, 112, 114, 116. In FIG. 1 the top parts of the resonators 110, 112, 114, 116 are what are known as free ends, which are galvanically separated from the casing C, particularly from a casing end C2. The other ends or sides of the casing C are indicated by references C3 and C4.

Correspondingly, in a second filter part on the right-hand side half of FIG. 1 the ends of the resonators 140, 142, 144, 146, i.e. the bottom parts of the resonators in FIG. 1, are short-circuited to a partition wall end 150 inside the casing C, the wall acting at the same time as a common ground for the resonators 140, 142, 144, 146. In FIG. 1 the top parts of the resonators 140, 142, 144, 146 are what are known as free ends, which are galvanically separated from the casing C, particularly from the casing end C2.

In the situation of the type in FIG. 1, the resonators are about a quarter-wavelength long.

The casing C may also comprise partition walls 180, 182, 184, 186 that prevent or reduce capacitive coupling between free resonator ends.

At a distance from an end of the resonators, e.g. from a short-circuited end, one or more coupling lines, e.g. 120, forming an integral piece with the resonators are provided between the sides of the resonators, e.g. 110, 112. In FIG. 1 the scale is 1:1 so the coupling lines 120, 222, 124 and 152, 154, 156 in the example of FIG. 1 are at a distance of about 1 to 3 cm from the ends, e.g. the short-circuited ends, of the resonators 110, 112,114, 116 and 140, 142, 144, 146. As regards their distance, the coupling lines may also be higher up or lower down than mentioned above, depending on the desired bandwidth of the filter and the desired positions for locations of zeros in the frequency response.

The distance of the coupling lines referred to above means their distance, as shown in FIG. 1, from the short-circuited bottom end of the resonators at the casing end C1. If the resonators in question are half-wavelength resonators, i.e. half wave long resonators, both resonator ends may be free, i.e. the bottom end does not need to be short-circuited to the casing end C1. In that case ‘distance’ refers to the distance from the resonator end. When both resonator ends are free, frequency adjustment (FIG. 4) may be carried out at either end or both ends. An incoming signal may be capacitively coupled by using a suitable coupling system in the vicinity of either one of the open ends, or a galvanic coupling to the middle of the resonator, where the minimum current is, may be performed. A half-wavelength resonator of the above type is practical at extremely high frequencies, e.g. within the 2 GHz range.

Between the resonators 110, 112 there is a coupling line 120; between the resonators 112, 114 there is a coupling line 122. Between the resonators 114, 116 there is a coupling line 124. The above is the situation in the first filter part. Correspondingly, in the second filter part there is a coupling line 152 between the resonators 140, 142, a coupling line 154 between the resonators 142, 144 and a coupling line 156 between the resonators 144, 146. The coupling lines form, as stated, an integral piece with the resonators, i.e. they are made of the same plate, such as a copper plate, either by using a blade tool to cut areas that are not needed or by machining the plate, or by etching, which is also a possible manufacturing method.

The coupling lines 120, 122, 124 and 152, 154, 156 increase the bandwidth of the filter F, which is necessary in filters of a bandwidth of about 100 MHz, for example. The bandwidth also depends on the transverse width of the coupling line, i.e. the coupling line width in the resonator direction, because a wider coupling line increases bandwidth.

It is noticed that the coupling line 120, 122, 124 and 152, 154, 156 that is between the resonator sides and forms an integral piece with the resonators 110, 112, 114, 116 and 140, 142, 144, 146 is closer to the short-circuited resonator ends than to the open ends, because closer to the grounded short-circuited resonator end there is a strong current and hence also a strong magnetic field, with which the signal, i.e. the desired amount of energy, is coupled to the second resonator. The grounded end is referred to as the inductive resonator end.

The resonators and the coupling lines integral with them form one plane piece and are, in particular, made of one uniform plate, such as a copper plate.

According to an embodiment, there is only one coupling line, e.g. 120, between the sides of two adjacent resonators, such as 110, 112, because in that case a certain amount of signal may be coupled by the coupling line 120 at a specific impedance level from the resonator 110, for example, to the adjacent resonator 112. The transfer line 102 after the signal port couples the signal at an impedance level suitable for the resonator 110.

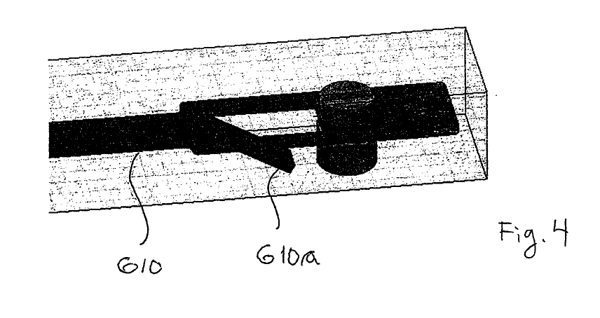

As shown in FIG. 1, the coupling lines 120, 122, 124 and 152, 154, 156 between the different resonators 110, 112, 114, 116, 140, 142, 144, 146 and integral with them are at different distances from the short-circuited end of the resonators. For example, the coupling line 122 between the resonators 112, 114 is further away from the short-circuited bottom ends of the resonators than the coupling line 120 between the resonators 110, 112. This enables the frequency response, i.e. the pass band and the stop band, to be modified in a desired manner. In FIG. 3, to be discussed below, capacitive cross coupling between adjacent resonators is added to the top end, i.e. the capacitive end, of the resonator, which means that inductive coupling at the bottom end, i.e. the inductive end, of the resonators must be increased either by widening the coupling line 122 or by implementing the coupling line 122 to a location where it is further away from the grounded short-circuited ends of the resonators.

Integration may be carried even further. According to an embodiment, as shown in FIG. 1, the one or more phasing lines 130 between the filter signal port and at least one resonator also belong, together with the resonator and the one or more coupling lines between them, to the same integral piece, such as one plane piece which is, in particular, made of one uniform plate, such as a copper plate. In FIG. 1 the branches of the phasing line 130 terminate at the sides of the resonators 116 and 140. In this 3-port filter, the branches of the phasing line 130 connect the filter blocks, or filter sections, to a common signal port over the transfer line 106.

Integration is further improved by the fact that, in addition to the resonators 110, 112, 114, 116, 140, 142, 144, 146 and the one or more coupling lines 120, 122, 124 and 152, 154, 156 between them, the same integral piece includes a transfer line 102, 104, 106 for attaching the signal port.

Integration and filter adjustment, such as tuning, are discussed next. With reference to FIGS. 3 and 4, one or more resonators are provided with a bendable adjustment member 410a to 412a, 610a forming an integral piece with the resonator for adjusting the operation of the RF filter. In other words, the resonators 110, 112, 114, 116, 140, 142, 144, 146 and the coupling lines 120, 122, 124 and 152, 154, 156 between them, as well as the phasing line 130 and the transfer lines 102, 104, 106 for attaching the signal port, and also the adjustment members 410a, 412a, 610a thus form one integral piece, such as one plane piece which is, in particular, made of one uni-uniform plate, such as a copper plate.

As shown in FIG. 3, the bendable adjustment member 410a, 412a, forming an integral piece with the resonator 410, 412 extends transversely from a resonator side towards an adjacent resonator 412, 410 and serves as an adjustment member for adjusting a capacitive coupling between the adjacent resonators. As regards the above and with reference to FIG. 3, the adjacent resonators 410, 412 both have a bendable adjustment member 410a, 412a forming an integral piece with the resonator 410, 412 and extending transversely from a resonator side towards the adjacent resonator 412, 410, the adjustment members 410a, 412a between these adjacent resonators being at least partly side by side in the area between the resonators because then an efficient adjustment of the capacitive coupling between the resonators 410, 412 is achieved. The structure of FIG. 3 enables the frequency response of the filter to be provided with locations for zeros, i.e. attenuation maximum locations, and, in particular, one location of a zero to be adjusted to a desired position in the frequency response.

The same principle is applied in the embodiment of FIG. 4, where the bendable adjustment member 610a forming an integral piece with the resonator 610 extends from a surface between the sides of the resonator 610 towards the filter casing C, particularly towards a cover T or a bottom B, and serves as an adjustment member for frequency adjustment. The lower down the protruding adjustment member 610a is bent, the lower the frequency of the filter will be set because the adjustment member 610a belonging to the resonator approaches the casing.

Hence, according to an embodiment the adjustment members 410a, 412a, 601a in the resonators and the coupling lines 120, 122, 124 and 152, 154, 156 between the resonators, and also the phasing line 132 and the transfer line 106 on the extension thereof and to be connected to the signal port, and the transfer lines 102, 104 all form one uniform integral piece with no joints. The structure has been obtained by working a plane piece, such as a copper plate.

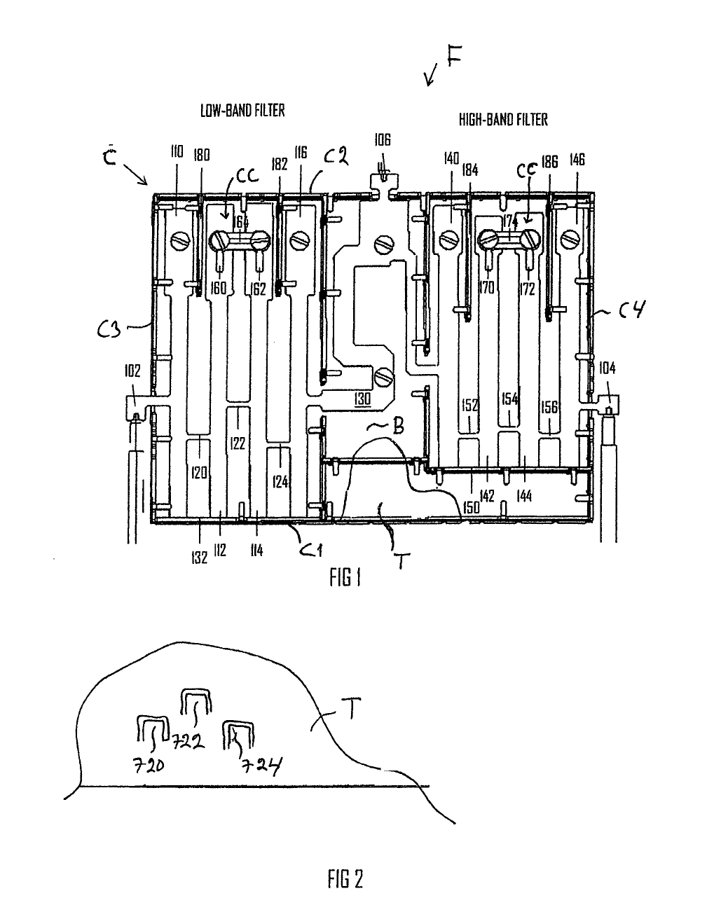

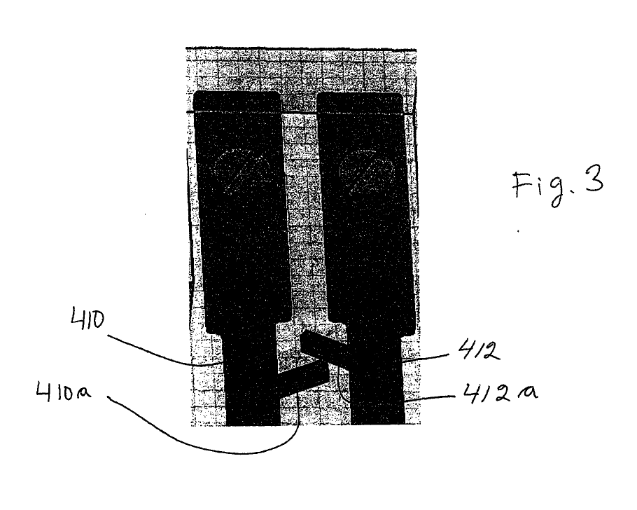

With reference to FIG. 2, the casing C, similarly as the casing cover T, has bendable adjustment members 720, 722, 724 that coincide with the coupling lines 120, 122, 124 between the resonators, i.e. they are on top of the coupling lines on the cover T. The structure of FIG. 2 allows the coupling between the resonators to be adjusted.

The integrated adjustment members 410a, 412a of FIG. 3 for capacitive coupling between the resonators replace the adjustment arrangement CC of FIG. 1, implemented by supplementary parts, the adjustment arrangement CC having an insulation between the resonators and, on top of that, a metal piece 164 (174) with bendable adjustment protrusions 160, 162 (170, 172). In FIGS. 3 and 1 to 2 the free ends of the resonators are supported to the casing by a screw made of the insulation material.

It is apparent to a person skilled in the art that as technology advances, the basic idea of the invention may be implemented in many different ways. The invention and its embodiments are thus not restricted to the above-described examples but may vary within the scope of the claims.

What is claimed is:

1. An RF filter, particularly a stripline type RF filter, comprising:
a casing; and
two or more strip-conductor-type resonators in the casing, wherein at a distance from an end of the resonators, between the resonator sides, there are one or more coupling lines forming an integral piece with the resonators.

2. An RF filter as claimed in claim 1, wherein the coupling line between the resonator sides and forming an integral piece with the resonators is closer to the short-circuited end than to the open end of the resonators.

3. An RF filter as claimed in claim 1, wherein the resonators and the coupling lines forming an integral piece with them are of the same plane piece.

4. An RF filter as claimed in claim 1, wherein there is only one coupling line between the sides of two adjacent resonators.

5. An RF filter as claimed in claim 1, wherein the coupling lines between the different resonators and integral with them are at a different distance from the short-circuited end of the resonators.

6. An RF filter as claimed in claim 1, wherein in addition to the resonators and the one or more coupling lines between them, one or more phasing lines between a filter signal port and at least one resonator also belong to the same integral piece.

7. An RF filter as claimed in claim 1, wherein one or more resonators are provided with a bendable adjustment member, forming an integral piece with the resonator, for adjusting the operation of the RF filter.

8. An RF filter as claimed in claim 7, wherein the bendable adjustment member forming an integral piece with the resonator extends transversely from a side of the resonator towards an adjacent resonator and serves as an adjustment member for adjusting a capacitive coupling between the adjacent resonators.

9. An RF filter as claimed in claim 8, wherein the adjacent resonators both have a bendable adjustment member forming an integral piece with the resonator and extending transversely from a side of the resonator towards the adjacent resonator and, in an area between the resonators, the adjustment members of the adjacent resonators are at least partly side by side.

10. An RF filter as claimed in claim 7, wherein the bendable adjustment member forming an integral piece with the resonator extends from a surface between the resonator sides towards the filter casing and serves as an adjustment member for frequency adjustment.

11. An RF filter as claimed in claim 1, wherein in addition to the resonators and the one or more coupling lines between them, the same integral piece includes a transfer line for attaching a signal port.
